(19) United States
(12) Patent Application Publication
(10) Pub. No.: US 2018/0239424 A1
(43) Pub. Date: Aug. 23, 2018

(54) OPERATION SYSTEM

(71) Applicant: DENSO CORPORATION, Kariya-city, Aichi-pref. (JP)

(72) Inventors: Shigeaki NISHIHASHI, Kariya-city (JP); Hiroyuki KOGURE, Kariya-city (JP); Hideki ITO, Kariya-city (JP); Tetsuya TOMARU, Kariya-city (JP); Yoshiyuki TSUDA, Kariya-city (JP); Takuya OSUGI, Kariya-city (JP)

(21) Appl. No.: 15/554,826

(22) PCT Filed: Mar. 4, 2016
(86) PCT No.: PCT/JP2016/001195

§ 371 Date: Aug. 31, 2017

(30) Foreign Application Priority Data
Mar. 25, 2015 (JP) 2015-063291

(51) Int. Cl. G06F 3/01; B60K 37/02; G06F 3/044; G06F 3/14

(52) U.S. Cl. CPC G06F 3/013; B60K 37/02; B60K 2350/1052; G06F 3/1423; B60K 2350/1024; G06F 3/044

(57) ABSTRACT

An operation system includes: an operation device that is manually operated by a user and inputs a command of an action content to a command target apparatus selected from a plurality of apparatuses; a plurality of display units that are individually arranged on the plurality of apparatuses and display information corresponding to the action content; and a selection device that selects one of the plurality of apparatuses as the command target apparatus according to a visual line direction of a user detected by a visual line detection sensor, the one of the plurality of apparatuses corresponding to one of the display units disposed in the visual line direction.

### CROSS REFERENCE TO RELATED APPLICATION

This application is based on Japanese Patent Application No. 2015-63291 filed on Mar. 25, 2015, the disclosure of which is incorporated herein by reference.

### TECHNICAL FIELD

The present disclosure relates to an operation system in which an operation device and sight line detection are cooperated with each other.

### BACKGROUND ART

Conventionally, there has been known an operation system which gives a command for action contents of a plurality of apparatuses using an operation device in common. In particular, there has been widely known an operation system mounted on a vehicle. In the operation system mounted on a vehicle, information corresponding to action contents of the corresponding apparatus is displayed on a display unit provided for each apparatus, and the operation device is operated while looking at the display so as to give a command for desired action contents. In this type of operation system, the operation device is operated in the following procedure. First, an operation for selecting any one of the plurality of apparatuses as a command target (selection operation) is performed. Then, an operation for giving a command for action contents to the selected apparatus (command operation) is performed.

In recent years, a sight line detection sensor which detects a sight line direction of a user is under development (refer to Patent Literature 1). This makes it possible to give a command for action contents merely by moving the sight line and eliminate the operation of the operation device.

However, an apparatus that requires a command for complicated action contents requires display of information corresponding to the action contents on the display unit. In this case, if the command is given by moving the sight line, for example, an operation of sequentially looking at icons on a menu screen displayed on the display unit is required, which makes a user feel troublesome. On the other hand, if the command is given using the operation device, a selection operation is required in addition to the above command operation, which is troublesome.

### PRIOR ART LITERATURES

### Patent Literature

Patent Literature 1: JP-5588764-B1

### SUMMARY OF INVENTION

It is an object of the present disclosure to provide an operation system having an improved ease of giving a command to an apparatus.

According to an aspect of the present disclosure, an operation system includes: an operation device that is manually operated by a user and inputs a command of an action content to a command target apparatus selected from a plurality of apparatuses; a plurality of display units that are individually arranged on the plurality of apparatuses and display information corresponding to the action content; and a selection device that selects one of the plurality of apparatuses as the command target apparatus according to a visual line direction of a user detected by a visual line detection sensor, the one of the plurality of apparatuses corresponding to one of the display units disposed in the visual line direction.

According to the above operation system, it is possible to give a command to change action contents by manually operating the operation device while looking at information corresponding to the action contents displayed on the display unit. Thus, even when there is a device that requires a command for complicated action contents, the command is easily given. In addition, selection of any one of the devices as the command target can be performed merely by looking at the display unit corresponding to the desired device. In short, a simple command such as the selection of the command target apparatus is performed using the visual line detection sensor, and a complicated command such as the setting of action contents is performed using the operation device. Accordingly, the present invention makes it possible to improve the ease of giving a command to the devices while achieving giving a command for action contents of the devices using the operation device in common.

### BRIEF DESCRIPTION OF DRAWINGS

The above and other objects, features and advantages of the present disclosure will become more apparent from the following detailed description made with reference to the accompanying drawings. In the drawings:

FIG. 1 is a perspective view illustrating vehicle-mounted positions of an operation device and a sight line detection sensor in a first embodiment of the present disclosure;

FIG. 2 is a diagram illustrating a relationship between display contents of display devices illustrated in FIG. 1 and a sight line direction of a user;

FIG. 3 is a control block diagram illustrating the operation device, a proximity sensor, the sight line detection sensor, and the display devices illustrated in FIG. 1; and

FIG. 4 is a flowchart illustrating a procedure of control by a microcomputer of FIG. 3.

### EMBODIMENTS FOR CARRYING OUT INVENTION

Hereinafter, one embodiment of an operation system according to the present invention will be described with reference to the drawings.

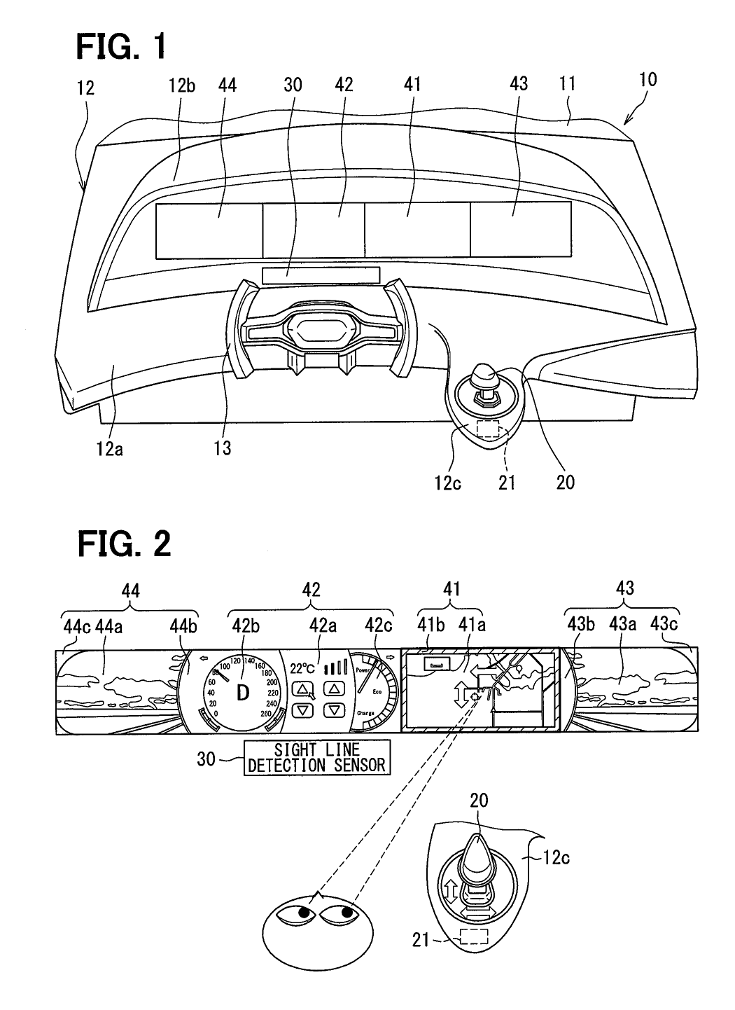

FIG. 1 is a perspective view of a vehicle front side viewed from the inside of a cabin of a vehicle 10. As illustrated, an instrument panel 12 which is made of a resin is installed under a front windshield 11 inside the vehicle cabin. The instrument panel 12 includes a horizontal portion 12a which expands in the horizontal direction, a projecting portion 12b which projects upward from the horizontal portion 12a, and an extending portion 12c which extends toward the rear side of the vehicle from the horizontal portion 12a. The projecting portion 12b has a shape including an opening which is open toward the rear side of the vehicle. A plurality of (four in an example of FIG. 1) display devices 41, 42, 43, 44 are disposed on the opening. The display devices 41, 42, 43, 44 are arranged in a row in a right-left direction of the vehicle 10 (a right-left direction of FIG. 1).

Each of the display devices 41, 42, 43, 44 is provided with a liquid crystal panel and a backlight. The display devices 41, 42, 43, 44 have the same shape and the same size. The display devices 41, 42, 43, 44 are adjacently arranged so that display surfaces of the liquid crystal panels are visually recognized as being continuous in the right-left direction of the vehicle, that is, visually recognized as one display surface extending in the right-left direction. In front view of the instrument panel 12, the display device arranged on the center right is referred to as the first display device 41, the display device arranged on the center left is referred to as the second display device 42, the display device arranged on the right end is referred to as the third display device 43, and the display device arranged on the left end is referred to as the fourth display device 44.

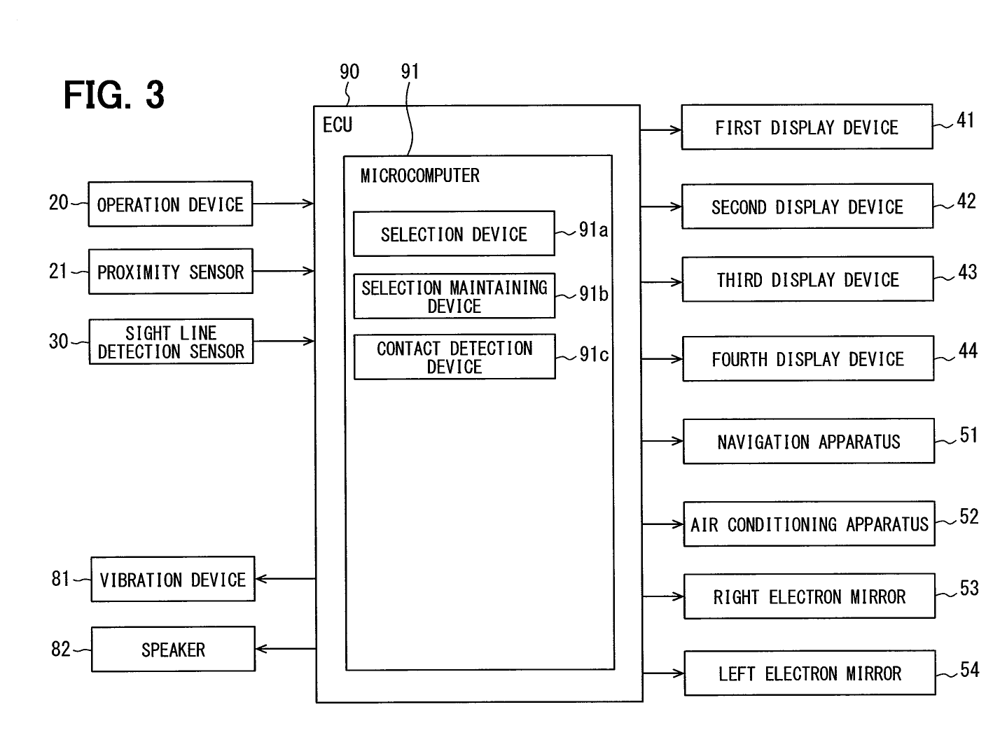

As illustrated in FIG. 2, areas for displaying information corresponding to action contents of various apparatuses (described below, refer to FIG. 3) are set in the liquid crystal panels of the display devices 41, 42, 43, 44. The areas are referred to as specific areas 41a, 42a, 43a, 44a. These areas correspond to “display units”.

As illustrated in FIG. 3, the vehicle 10 is equipped with apparatuses including a navigation apparatus 51, an air conditioning apparatus 52, a right electron mirror 53, a left electron mirror 54, and an audio apparatus (not illustrated). The navigation apparatus 51 navigates travel of the vehicle 10. The air conditioning apparatus 52 controls air conditioning inside the vehicle cabin. The right electron mirror 53 is provided with a camera which captures an image of an object outside the vehicle such as another vehicle or a pedestrian, the object being located on the right side of the vehicle 10, and an actuator which controls an image capturing direction of the camera. The left electron mirror 54 is provided with a camera which captures an image of an object outside the vehicle, the object being located on the left side of the vehicle 10, and an actuator which controls an image capturing direction of the camera.

Information corresponding to action contents of the navigation apparatus 51 is displayed in the specific area 41a of the first display device 41. For example, map information, current position information of the vehicle 10, position information of a destination, and traveling route information are displayed. Further, a highlighting display frame is displayed in a frame area 41b which is an area other than specific area 41a in the first display device 41. The frame area 41b is set in an annular shape surrounding the specific area 41a. The frame area 41b corresponds to a “selection notification display unit”.

Information corresponding to action contents of the air conditioning apparatus 52 is displayed in the specific area 42a of the second display device 42. For example, information such as the temperature, the volume, and a blow-off port of air conditioning air is displayed. Further, a vehicle speed meter and a battery residual meter are displayed in meter areas 42b, 42c which are areas other than the specific area 42a in the second display device 42. The meter areas 42b, 42c and the specific area 42a are arranged in a row in the right-left direction of the vehicle. The specific area 42a is arranged between the two meter areas 42b, 42c.

Information corresponding to action contents of the right electron mirror 53, that is, an image captured by the camera whose direction is controlled by the actuator is displayed in the specific area 43a of the third display device 43. Further, an image (e.g., a black-painted image) different from the image captured by the camera is displayed in areas 43b, 43c other than the specific area 43a in the third display device 43. The specific area 41a of the first display device 41, and the specific area 43a and the area 43b of the third display device 43 are arranged in a row in the right-left direction of the vehicle. The area 43b is arranged between the two specific areas 41a, 43a. Accordingly, the two specific areas 41a, 43a are arranged at a predetermined interval or more in the right-left direction of the vehicle.

Information corresponding to action contents of the left electron mirror 54, that is, an image captured by the camera whose direction is controlled by the actuator is displayed in the specific area 44a of the fourth display device 44. Further, an image (e.g., a black-painted image) different from the image captured by the camera is displayed in areas 44b, 44c other than the specific area 44a in the fourth display device 44. The specific area 42a of the second display device 42, and the area 44b and the specific area 44a of the fourth display device 44 are arranged in a row in the right-left direction of the vehicle. The area 44b is arranged between the two specific areas 41a, 44a. Accordingly, the two specific areas 41a, 44a area arranged at a predetermined interval or more in the right-left direction of the vehicle.

The vehicle 10 is equipped with an electronic control device (ECU 90) described below, an operation device 20, and a sight line detection sensor 30 in addition to the display devices 41, 42, 43, 44 and the various apparatuses. An operation system according to the present embodiment is provided with the operation device 20, the plurality of display devices 41 to 44, and the ECU 90. The operation device 20 is manually operated by a user to give a command for action contents to a command target apparatus selected from the plurality of apparatuses. The selection is performed by the sight line detection sensor 30 and the ECU 90.

The operation device 20 is disposed on the extending portion 12c at a position within the reach of a driver (user) of the vehicle 10 seated on a driver's seat. In the example of FIG. 1, a steering wheel 13 for controlling a traveling direction of the vehicle 10 is disposed at the left side in the right-left direction of the vehicle, and the operation device 20 is disposed at the opposite side (the right side) of the steering wheel 13. Specifically, the operation device 20 is disposed at the center in the right-left direction of the vehicle inside the vehicle cabin. The operation device 20 is operated by a user in three directions: an x-axis direction, a y-axis direction, and a z-axis direction. The x-axis direction corresponds to the right-left direction of the vehicle, the y-axis direction corresponds to the front-rear direction of the vehicle, and the z-axis direction corresponds to an up-down direction. That is, a tilting operation in the x-axis direction and the y-axis direction and a pushing operation in the z-axis direction can be performed.

For example, a display mode illustrated in FIG. 2 shows a state in which the navigation apparatus 51 is selected as the command target apparatus. When the operation device 20 is tilted in the x-axis direction or the y-axis direction in this state, a map displayed in the specific areas 41a of the first display device 41 is scrolled in the right-left direction or the up-down direction (refer to arrows in FIG. 2). Alternatively, a selected one of a plurality of icons displayed in the specific areas 41a is switched. When the operation device 20 is pushed in the z-axis direction, the selected icon is confirmed, and designation associated with the selected icon is output to the navigation apparatus 51. The navigation apparatus 51 acts in accordance with the command, and the contents of the action are displayed in the specific areas 41a.

A proximity sensor 21 is attached to the extending portion 12c of the instrument panel 12. The proximity sensor 21 changes an output signal in response to the approach of a detection target. A microcomputer 91 of the ECU 90 detects a state in which a user is laying his/her hand on the operation device 20 on the basis of a change in a signal output from the proximity sensor 21. The microcomputer 91 during the execution of the detection corresponds to a “contact detection device 91c”. The proximity sensor 21 may output an ON signal when a detection target has approached a position within a predetermined range. In this case, the contact detection device 91c detects a state in which a user is laying his/her hand on the operation device 20 upon acquisition of the ON signal.

The sight line detection sensor 30 includes an infrared camera which is attached to a part of the instrument panel 12 that is located in front of a driver and a microcomputer for image analysis. The infrared camera captures an image of right and left eye balls of a driver, and the microcomputer analyzes the captured image to calculate the sight line direction of the driver. The image analysis may be executed by the microcomputer (the microcomputer 91) included in the ECU 90.

The microcomputer 91 of the ECU 90 selects, on the basis of a sight line direction of a user detected by the sight line detection sensor 30, an apparatus corresponding to the specific area within the sight line direction as the command target apparatus. The microcomputer 91, when selecting the command target apparatus in this manner, corresponds to a “selection device 91a”. For example, when the display unit within the sight line direction is the specific area 41a of the first display device 41 as illustrated in FIG. 2, the navigation apparatus 51 corresponding to the specific area 41a is selected as the command target apparatus by the selection device 91a.

During a period when a state in which a user is laying his/her hand on the operation device 20 is detected by the contact detection device 91c, sight line detection by the sight line detection sensor 30 is enabled, and the selection device 91a executes the above selection. Even when the sight line direction is changed to a position deviated from all the specific areas 41a, 42a, 43a, 44a with any of the apparatus selected as the command target apparatus, the microcomputer 91 maintains the current selection. The microcomputer 91, when functioning in this manner to maintain the selection, corresponds to a “selection maintaining device 91b”.

A vibration device 81 (notification device) illustrated in FIG. 3 is attached to a steering or the driver's seat to apply vibrations to a user. A speaker 82 (notification device) outputs an alarm sound or a voice. For example, a user is notified of various states such as when the selection has been confirmed and when the selection has been changed using vibrations, an alarm sound, or a voice.

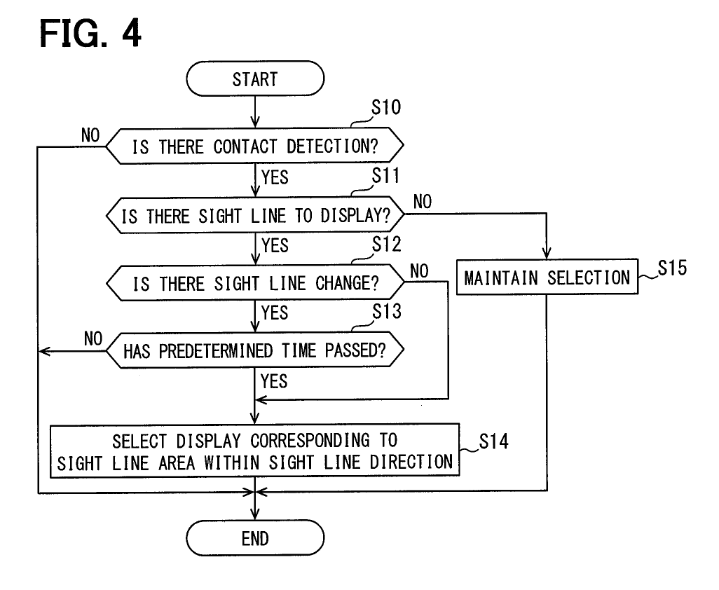

FIG. 4 is a flowchart illustrating a procedure of processing which is repeatedly executed by the microcomputer 91 at a predetermined operation period. First, in step S10, the presence or absence of contact detection by the proximity sensor 21 is determined. When the contact detection is determined to be present, it is estimated that a user is laying his/her hand on the operation device 20. Accordingly, it is considered that the user has an intention of giving a command to an apparatus using the operation device 20, and a move to the next step S11 is made. In step S11, it is determined whether the user is looking at any of the display units, that is, whether any of the display units is within a sight line direction detected by the sight line detection sensor 30. Specifically, it is determined whether any of the specific areas 41a, 42a, 43a, 44a is located within the sight line direction.

When there is a sight line to a display unit, it is determined whether there is a change of the sight line. Specifically, when the display unit having the current sight line differs from the display unit corresponding to the currently selected apparatus, it is determined that there is a change of the sight line. When none of the apparatuses is currently selected, it is determined that there is no change of the sight line.

When it is determined that there is a sight line change, it is determined whether a predetermined time or more of the sight line change has passed in the following step S13. When it is determined that the predetermined time or more has passed in step S13, or when it is determined that there is no sight line change in step S12, a move to the next step S14 is made. In step S14, an apparatus corresponding to the display unit present within the sight line direction is selected as the control target apparatus.

When it is determined that the predetermined time or more has not passed in step S13, the processing is finished without executing the selection by step S14, and a return to step S10 is made. When it is determined that the user is looking at none of the display units in step S11, the selection of the currently selected apparatus is maintained in step S15. For example, when the user takes his/her eyes off the display unit corresponding to the command target apparatus and shifts the sight line to the front of the vehicle 10 through the front windshield 11, the selection of the apparatus is maintained.

As described above, the present embodiment includes the operation device 20 which is manually operated by a user and gives a command for action contents to one of a plurality of apparatuses selected as a command target apparatus, the display units which are provided for the respective apparatuses and display information corresponding to the action contents, and the selection device 91a. The selection device 91a selects, on the basis of a sight line direction of a user detected by the sight line detection sensor 30, the apparatus corresponding to the display unit within the sight line direction as the command target apparatus.

Accordingly, it is possible to give a command to change action contents by manually operating the operation device 20 while looking at information corresponding to the action contents displayed on the display unit. For example, in the example of FIG. 2, the navigation apparatus 51 is selected as the command target apparatus, and it is possible to scroll map information displayed in the specific area 41a by manually operating the operation device 20 while looking at the map information. Thus, it is possible to easily give a command to even an apparatus that requires a command for complicated action contents.

In addition, selection of any one of the apparatuses as the command target apparatus can be performed merely by looking at the display unit corresponding to the desired apparatus. For example, when the sight line is shifted to the specific area 42a of the second display device 42 in a state of FIG. 2 in which the navigation apparatus 51 is selected as the command target apparatus, the apparatus (the air conditioning apparatus 52) corresponding to the second display device 42 is selected as the command target apparatus. In short, a simple command such as the selection of the command target apparatus is performed using the sight line detection sensor 30, and a complicated command such as the setting of action contents is performed using the operation device 20. Accordingly, the present embodiment makes it possible to improve the ease of giving a command to the apparatuses while achieving giving a command for action contents of the apparatuses using the operation device 20 in common.

Further, in the present embodiment, the selection maintaining device 91b is provided. Even when the sight line direction is changed to a position deviated from all the display units with the command target apparatus selected, the selection maintaining device 91b maintains the selection. This makes it possible to prevent the selection from being canceled every time the sight line is moved off the selected display unit and avoid troublesomeness caused by looking at the desired display unit to perform selection again every time the sight line is moved off the display unit. Further, it is also possible to operate the operation device 20 to give a command with the sight line off the display unit.

Further, in the present embodiment, the contact detection device 91c is provided. The contact detection device 91c detects that a user is in contact with the operation device 20. During a period when contact is detected by the contact detection device 91c, the selection device 91a enables sight line detection by the sight line detection sensor 30 and executes the selection. Accordingly, it is possible to avoid troublesomeness caused by selection of an apparatus corresponding to the display unit within the sight line direction when a user is not in contact with the operation device 20, that is, when a user has no intention of giving a command to the apparatus.

Further, in the present embodiment, when the sight line detection sensor 30 has detected a sight line movement to a display unit that is different from one of a plurality of display units associated with the command target apparatus and a time of the sight line movement is less than a predetermined time, the selection of the command target apparatus is maintained. Accordingly, merely a short look at another display unit does not change the selection. Thus, it is possible to look at another display unit without changing the selection of the command target apparatus.

Further, in the present embodiment, the selection notification display unit (frame area 41b) is provided. The selection notification display unit gives notice of selecting the display unit corresponding to the command target apparatus by the selection device 91a. This makes it easy for a user to recognize which one of the apparatuses is currently selected as the command target apparatus. Thus, it is possible to further improve the ease of giving a command to the apparatuses.

Further, in the present embodiment, the plurality of display units are disposed on the instrument panel 12 which is disposed on the front side inside the cabin of the vehicle 10 and arranged side by side in the right-left direction of the vehicle 10. A user who is driving the vehicle 10 moves the sight line to a position above the instrument panel 12 with a high frequency in order to check a condition in front of the vehicle 10 (foreground) with eyes through the front windshield 11. Thus, when the display units are disposed on the instrument panel 12, the sight line direction is moved in the up-down direction with a high frequency. On the other hand, when a plurality of display units are arranged side by side in the up-down direction dissimilarly to the present embodiment, it is difficult to distinguish between a sight line movement to the foreground and a sight line movement to the display unit. Thus, there is an apprehension that the selection device 91a may perform erroneous selection using the sight line detection sensor 30. On the other hand, the present embodiment in which the display units are arranged side by side in the right-left direction makes it possible to reduce the apprehension.

Further, in the present embodiment, the display units are arranged at predetermined intervals or more in the right-left direction of the vehicle 10. For example, in the case illustrated in FIG. 2, the area 43b is arranged between the two specific areas 41a, 43a. Further, the meter area 42c is arranged between the two specific areas 41a, 42a.

However, when a plurality of display units are adjacently arranged in the right-left direction dissimilarly to the present embodiment, it is difficult, when a user is looking at the boundary between two display units, to determine which one of the two display units is within the sight line direction. Thus, there is an apprehension that the selection device 91a may perform erroneous selection using the sight line detection sensor 30. On the other hand, the present embodiment in which the display units are arranged at predetermined interval or more makes it possible to reduce the above apprehension.

### Other Embodiments

The preferred embodiments of the disclosure have been described above. However, the disclosure is not limited at all to the above embodiments, and can be modified and implemented in various manners as described below. In addition to a combination of configurations clearly stated in the respective embodiments, configurations of a plurality of embodiments may be partially combined even if not clearly stated unless there is an obstacle in the combination.

The proximity sensor 21 illustrated in FIGS. 1 and 2 may either a contactless sensor or a contact sensor. Further, the proximity sensor 21 may either a sensor that detects a change in a magnetic field or a sensor that detects a change in capacitance. The attachment position of the proximity sensor 21 is not limited to the extending portion 12c. For example, the proximity sensor 21 may be attached to the operation device 20.

The proximity sensor 21 may be eliminated, and the contact detection device 91c may detect contact when an input signal generated by operating the operation device 20 is output. For example, the contact detection device 91c may detect that a user is laying his/her hand on the operation device 20 on the basis of a tilting operation or a pushing operation of the operation device 20.

In the embodiment illustrated in FIG. 1, the display devices 41, 42, 43, 44 are disposed on the opening of the instrument panel 12. However, the present disclosure is not limited to such disposition. For example, the display devices may be disposed on a dashboard.

In the embodiment illustrated in FIG. 1, the plurality of display devices 41, 42, 43, 44 are arranged in a row in the right-left direction of the vehicle. However, the present disclosure is not limited to such arrangement. For example, the display devices may be arranged at positions shifted from each other in the up-down direction.

In the embodiment illustrated in FIG. 1, the operation device 20 is disposed on the instrument panel 12. However, the present disclosure is not limited to such disposition. For example, the operation device 20 is disposed on the steering wheel 13.

The devices and/or functions provided by the ECU 90 (control device) can be provided by software recorded in a substantial storage medium and a computer that executes the software, software only, hardware only, or a combination thereof. For example, when the control device is provided by a circuit as hardware, the control device can be provided by a digital circuit including many logic circuits or an analog circuit.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An operation system comprising:
an operation device that is manually operated by a user and inputs a command of an action content to a command target apparatus selected from a plurality of apparatuses;
a plurality of display units that are individually arranged on the plurality of apparatuses and display information corresponding to the action content; and
a selection device that selects one of the plurality of apparatuses as the command target apparatus according to a visual line direction of a user detected by a visual line detection sensor, the one of the plurality of apparatuses corresponding to one of the display units disposed in the visual line direction.

2. The operation system according to claim 1, further comprising:
a selection maintaining device that maintains a selection state of the command target apparatus when the visual line direction is changed to another direction pointing to none of the plurality of display units while the command target apparatus is selected.

3. The operation system according to claim 1, further comprising:
a contact detection device that detects that the user touches the operation device, wherein:
the selection device activates a visual line detection of the visual line detection sensor and selects the command target apparatus during a period when the contact detection device detects a touch.

4. The operation system according to claim 1, wherein:
a selection state of the command target apparatus is maintained when the visual line detection sensor detects a visual line movement to another one of the display units different from the one of the display units corresponding to the command target apparatus, and a period of the visual line movement is less than a predetermined time.

5. The operation system according to claim 1, further comprising:
a selection notification display unit that notifies that the selection device selects the one of the plurality of display units corresponding to the command target apparatus.

6. The operation system according to claim 1, wherein:
the plurality of display units are arranged on an instrument panel disposed on a front side of a compartment of a vehicle, and are arranged next to each other in a right-left direction of the vehicle.

7. The operation system according to claim 6, wherein:
the plurality of display units are arranged at predetermined intervals or more to be spaced apart from each other in the right-left direction of the vehicle.
